(19) United States
(12) Patent Application Publication
(10) Pub. No.: US 2005/0142282 A1
(43) Pub. Date: Jun. 30, 2005

(54) Process for making water-repellent electrode

(76) Inventors: Yu-Chen Chang, Taipei (TW); Huan-Hsiung Tseng, Miaoli County (TW); Jia-Yun Jiang, Pingjhen (TW); Hung-Wen Chen, Taoyuan (TW); Chih-Wei Chu, Miaoli County (TW); Li-Chen Chang, Yonghe (TW)

Correspondence Address: Yu-Chen Chang, P. O. Box 55-846, Taipei, 104, TW

(21) Appl. No.: 11/013,042

(22) Filed: Dec. 16, 2004

(30) Foreign Application Priority Data
Dec. 31, 2003 (TW) 92137610

(51) Int. Cl. B05D 5/12; B05D 1/12

(52) U.S. Cl. 427/58; 427/258; 427/180

(57) ABSTRACT

A process for making water-repellent electrode comprises: A. mixing Pt/C catalyst powder with a solvent and ionomer for forming an ionomer-coated catalyst powder; B. mixing carbon fiber, carbon powder with a solvent and a hydrophobic polymer for forming a hydrophobic powder coated with the hydrophobic polymer; and C. homogeneously blending the catalyst powder and the hydrophobic powder in a solvent for forming a suspension, which is then filtered and printed on a carbon paper or carbon cloth by transfer printing, and further dried to obtain a hydrophobic electrode.

### BACKGROUND OF THE INVENTION

U.S. Pat. No. 5,501,915 to Graham A. Hards et al. disclosed a porous electrode suitable for use in a membrane electrode assembly for solid polymer fuel cells comprises a highly dispersed precious metal catalyst on particulate carbon impregnated with proton conducting polymer, and a further component comprising hydrophobic polymer and a dispersion of particulate carbon, demonstrating high effective platinum surface area and power density output when fabricated into a membrane electrode assembly.

The prior art does not incorporate carbon fiber into the components of the electrode. Since carbon fiber has an aspect ratio greater than that of carbon powder or particulate carbon, the carbon fiber may be provided to increase the water repellency of the catalyst layer of the electrode, thereby increasing the power density of the fuel cell.

The present inventor has found this phenomena and invented the present process for making fuel cell electrode by incorporating carbon fiber into the components of the electrode to improve the water repellency of the electrode in order for increasing the efficiency of the fuel cell.

### SUMMARY OF THE INVENTION

The object of the present invention is to provide a process for making water-repellent electrode of fuel cell comprising:
A. mixing Pt/C catalyst powder with a solvent and ionomer for forming an ionomer-coated catalyst powder;
B. mixing carbon fiber, carbon powder with a solvent and a hydrophobic polymer for forming a hydrophobic powder coated with the hydrophobic polymer; and
C. homogeneously blending the catalyst powder and the hydrophobic powder in a solvent for forming a suspension, which is then filtered and printed on a carbon paper or carbon cloth by transfer printing, and further dried to obtain a hydrophobic electrode.

### BRIEF DESCRIPTION OF THE DRAWINGS

FIG. 1 shows a relationship of the power density (P.D.) of three-fuel cells of the present invention (10˜30% fiber content in the anode) and a comparative fuel cell (no fiber) versus the current density (C.D.) of the corresponding fuel cells under normal pressure; wherein A indicates electrode area; Pta/Ptc being Pt. loading in anode/Pt. loading in cathode; Pa/Pc being anode pressure (normal pressure, N.P.)/cathode pressure (normal pressure, N.P.); and Ta/Tc Tca being anode temperature/cell temperature/cathode temperature.

FIG. 2 shows the relationship of the power density versus the current density of the fuel cells similar to the situation as shown in FIG. 1, except that the data are obtained under back pressure, i.e., Pa/Pc=10 psi/20 psi.

FIG. 3 shows the relationship of cell potential (C.P.) of the present invention (30% fiber) and the comparative example (no fiber) versus the time (T min.) factor.

### DETAILED DESCRIPTION

The present invention will be described in detail with reference to the examples as given hereinafter. The examples are provided to explain the present invention, but not for limiting the scope of the present invention within these examples.

### EXAMPLE 1

### Preparation of Carbon Fiber

Carbon paper or cloth is cut into chips, each having a length of 1˜2 mm, which are soaked in liquid nitrogen. The soaked chips are then ground by mortar or grinding mill, and further dried at 40° C. to have a constant weight to obtain carbon fiber having diameter (or thickness) of 1˜20 μm.

### EXAMPLE 2

### Preparation of Carbon Fiber

Another method for preparing carbon fiber is conducted by cutting carbon paper or cloth into chips, each having a length of 1˜2 mm. The chips are then impregnated and mixed in an aqueous solution of isopropyl alcohol (with a ratio of pure water/isopropanol=3:2), which is agitated and shredded in a high shear agitator. The mixed solution is filtered on a filter paper, which is then dried at 40° C. in an oven to have a constant weight to obtain the carbon fiber having a diameter (thickness) of 1˜20 μm.

### EXAMPLE 3

### Preparation of Nafion-Coated Catalyst Powder

In beaker A, one gram of 20 wt. (weight)% Pt/C and 150 ml ultra pure water are added therein for preparing suspension I. A mixed solvent containing extra pure water and isopropanol is prepared in beaker B, from which the mixed solvent 120 ml is then poured into beaker A. The suspension in beaker A is well dispersed and mixed by an ultrasonic vibrator, and heated to 50° C. Then, 5 wt. % Nafion solution (Nafion: Pt=3:1) is added into the beaker A for continuous agitation until obtaining a paste-like product. The paste product is dried to constant weight in a high-temperature oven to obtain a black powder, namely, the desired Nafion-coated catalyst powder. (Note: The Nafion is a proton conducting polymer or an ionomer of Dupont product).

### EXAMPLE 4

### Preparation of PTFE-Coated Hydrophobic Powder of Particulate

Carbon

One gram of carbon powder is added into 100 ml distilled water of 70° C. to prepare a suspension II. The suspension II is then heated to 40° C. and 0.4 ml 60 wt. % PTFE (a hydrophobic polymer of polytetrafluoro-ethylene) suspension is added thereinto. Then, it is filtered and the residue on the filter paper is placed into a crucible and baked under a nitrogen atmosphere of 300° C. to obtain the PTFE-coated hydrophobic powder of particulate carbon (or carbon powder).

### EXAMPLE 5

### Preparation of PTFE-Coated Hydrophobic Powder of Carbon Fiber

One gram of carbon fiber is added into 100 ml distilled water of 70° C. to obtain a suspension III, which is heated to 40° C. and further added therein with 0.4 ml 60 wt % PTFE suspension. The suspension III is then filtered. The residue on the filter paper is placed into a crucible and baked under nitrogen gas of 300° C. to thereby obtain PTFE-coated hydrophobic powder of carbon fiber.

### EXAMPLE 6

### Preparation of Anode

The Nafion-coated catalyst powder as prepared by Example 3 is proportionally blended with the PTFE-coated hydrophobic powder of carbon powder and carbon fiber as made by Examples 4 and 5 respectively in a ratio of 2:1 (catalyst powder:hydrophobic powder=2:1). The blended components, 0.25 gram, are placed in a beaker C, wherein 150 ml of mixed solvent of extra pure water and isopropanol (a ratio of 3:2) is added. The blended solution is then homogeneously dispersed and mixed by a high shear agitator to form a suspension, which is then filtered on a filter paper, 5 cm×5 cm in size. The powder layer on the filter paper is then printed on a carbon paper or cloth by transfer printing process. Such a carbon paper (or cloth) coated with catalyst layer thereon is then baked in a vacuum oven at 40° C. to thereby obtain the anode electrode.

### EXAMPLE 7

### Preparation of Cathode

The Nafion-coated catalyst powder as prepared by Example 3 is proportionally blended with the PTFE-coated hydrophobic powder of carbon powder and carbon fiber as made by Examples 4 and 5 respectively in a ratio of 2:1 (catalyst powder:hydrophobic powder 2:1). The blended components, 0.25 gram, are placed in a beaker C, wherein 150 ml of mixed solvent of extra pure water and isopropanol (a ratio of 3:2) is added. The blended solution is then homogeneously dispersed and mixed by a high shear agitator to form a suspension, which is then filtered on a filter paper, 5 cm×5 cm. The powder layer on the filter paper is then printed on a carbon paper or cloth by transfer printing process. Such a carbon paper (or cloth) coated with catalyst layer thereon is then baked in a vacuum oven at 40° C. to thereby obtain the cathode electrode.

### EXAMPLE 8

### Preparation of Membrane Electrode Assembly

The anode and cathode as respectively prepared by Examples 6 and 7 are provided for making the membrane electrode assembly (MEA) as below-mentioned. The anode loading is 0.5 mg Pt/cm², while the cathode loading being 1.0 mg Pt/cm².

On the surface of catalyst layers of the two electrodes, a 5% Nafion solution is brush-coated to obtain a loading of 0.6 mgNafion/cm² of the cathode. A proton exchange membrane of Nafion-117 of Dupout product is sandwiched inbetween two opposite catalyst layers as respectively coated on the anode and cathode. Such a “sandwiched lamination” is then processed by hot press at 140° C. under 7 atms. to obtain the membrane electrode assembly of the present invention.

### EXAMPLE 9

### First Testing Example

A cathode and an anode are prepared according to Examples 7 and 8 as previously mentioned. The cathode contains no carbon fiber therein and the anode is added therein with carbon fiber for 10%, 20% and 30% (based on the weight percentage of hydrophobic powder).

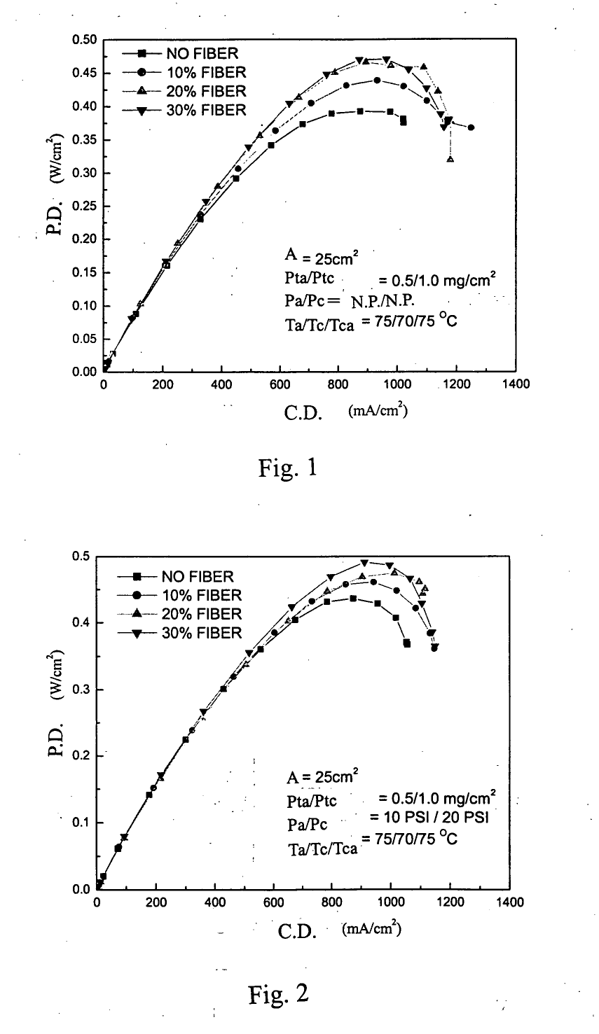

A membrane electrode assembly is prepared according to the above-mentioned Example 8. By this way, three fuel cells having carbon fiber content in anode of 10%, 20% and 30%, respectively, of the present invention and a comparative fuel cell contain no carbon fiber are prepared for testing their power density (P.D., W/cm²) versus current density (C.D., mA/cm²), showing the testing result in FIG. 1. In this example, the pressure at anode (Pa) and the pressure at cathode (Pc) are at normal pressure (N.P.). The effective electrode area of MEA is 25 cm²; cell temperature (Tc) being 70° C. and electrode temperature (Ta or Tca) being 75° C. Platinum loading at anode is 0.5 mg/cm², while Pt. loading at cathode being 1.0 mg/cm² From the testing result as shown in FIG. 1, it clearly indicates that the cell efficiency in term of power density increases with increasing carbon fiber content in accordance with the present invention especially in the region of higher current density (C.D.). Namely, the power density of 30% fiber content is greater than that of 20% and 10% fiber content, respectively. Comparatively, the zero % fiber content of the comparative cell for control test remarkably shows a lower power density than that of the present invention.

Accordingly, due to the addition of the carbon fiber in the cathode of the fuel cell, the water repellency of the cathode will be enhanced to thereby increase the output power density and the cell efficiency of the fuel cell to be superior to the prior art.

### EXAMPLE 10

### Second Testing Example

The Example 9 is repeated, except that the back pressure at anode (Pa) is set at 10 psi, while the back pressure at cathode (Pc) is set at 20 psi. The testing result is shown in FIG. 2. Similarly, upon an increase of the carbon fiber content in the cathode, the power density (P.D.) or cell efficiency of the fuel cell will be increased especially when the current density (C.D.) is increased. For instance, the maximum power density with 30% fiber content of the present invention is 0.495 W/cm², which has been remarkably increased from the maximum power density of 0.42 W/cm² of 0% fiber content of the comparative cell as shown in FIG. 2. This reflects that the mass transfer of gas and liquid water under higher current density will be correspondingly increased, thereby resulting in a higher power density or cell efficiency of the present invention than that of the prior art.

### EXAMPLE 11

### Third Testing Example

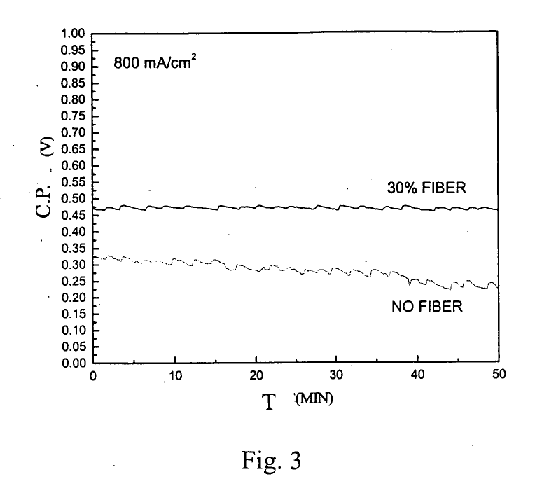

Following the previous examples of the present invention, the anode, cathode and MEA are prepared for testing cell potential (C.P., volts) at constant current of 800 mA/cm² with respect to time (50 minutes) for the present invention having 30% fiber content in comparison with the prior art of 0% fiber content. The testing result is shown in FIG. 3.

From the result as shown in FIG. 3, the cell potential (C.P.) of a single cell of this invention is generally maintained at about 0.45 V during the testing period.

Comparatively, the cell potential of the comparative cell (0% fiber content) is gradually decreased from 0.325 V to 0.225 V during the testing period, to be greatly decreased than that (0.45V) of the present invention. The higher cell potential as effected by the present invention demonstrates a high cell efficiency of fuel cell can be obtained by the present invention than that of the prior art.

The carbon fiber as used in this invention may have a length ranging from 0.01˜10,000 μm or even longer, depending on the physical dimension of the catalyst layer and other related factors; and the fiber diameter ranging from 1 μm˜500 μm. The carbon fiber may have a content of at least 0.1 weight % (based on total weight of the hydrophobic powder). The carbon fiber may be selected from graphitized carbon fiber in this invention. However, the fiber size and content may be varied when used, not limited in this invention.

The present invention may be further modified without departing from the spirit and scope of the present invention.

The catalyst powder of platinum on particulate carbon (Pt/C) may also be modified to be powder of platinum alloy, gold, gold alloy or other precious metals. Besides the solvent of isopropanol, other alcohols having carbon number ranging from 1˜4 may also be used in this invention.

1. A process for making water-repellent electrode, comprising the steps of:
A. mixing catalyst powder of precious metal or metal alloy on particulate carbon with a first solvent and an ionomer for forming an ionomer-coated catalyst powder;
B. mixing carbon fiber, carbon powder with a second solvent and a hydrophobic polymer for forming a hydrophobic powder coated with the hydrophobic polymer; and
C. homogeneously blending the catalyst powder and the hydrophobic powder in a third solvent for forming a suspension, which is then filtered on a fiter paper to collect the powder residue, and printing the powder residue on a carbon paper or carbon cloth which is further dried to obtain a hydrophobic electrode.

2. A process according to claim 1, wherein said ionomer is polyperfluorosulfonic acid.

3. A process according to claim 1, wherein said hydrophobic polymer is polytetrafluoro-ethylene.

4. A process according to claim 1, wherein said carbon fiber is a graphitized carbon fiber.

5. A process according to claim 1, wherein said carbon fiber has a content ranging from 0.1˜100 weight % based on the total weight of carbon fiber and carbon powder in said hydrophobic powder.

6. A process according to claim 1, wherein said carbon powder has a content ranging from 0˜99.9 weight % based on the total weight of carbon fiber and carbon powder in said hydrophobic powder.

7. A process according to claim 1, wherein said first solvent, said second solvent and said third solvent are each selected from the group consisting of water and a mixed solvent consisting of water and alcohol having carbon number ranging from 1˜4.

8. A process according to claim 7, wherein said alcohol is isopropanol.

9. A process according to claim 1, wherein said carbon fiber has a length ranging from 0.01˜100,000 μm; and a thickness (or diameter) of 1˜500 μm.

10. A process according to claim 1, wherein the step for forming the hydrophobic powder comprises: the mixing of carbon fiber and carbon powder in ultra pure water for forming a suspension; heating the suspension and adding therein a polytetrafluoro-ethylene polymer for further filtration; and collecting the powder residue from the filtration into a crucible for baking under nitrogen atmosphere of 300° C. to obtain a PTFE-coated hydrophobic powder of carbon fiber and carbon powder.

11. A process according to claim 1, wherein said precious metal or metal alloy is selected from the group consisting of: platinum, platinum alloy, gold and gold alloy.
